(19) United States
(12) Patent Application Publication
(10) Pub. No.: US 2014/0237019 A1
(43) Pub. Date: Aug. 21, 2014

(54) SERVER-SIDE TRANSCODING OF MEDIA FILES

(71) Applicant: DROPBOX, INC., San Francisco, CA (US)

(72) Inventor: Pierpaolo Baccichet, San Francisco, CA (US)

(73) Assignee: DROPBOX, INC., San Francisco, CA (US)

(21) Appl. No.: 13/768,963

(22) Filed: Feb. 15, 2013

(51) Int. Cl. H04L 29/06

(52) U.S. Cl. CPC H04L 29/06047
USPC 709/203

(57) ABSTRACT

The disclosed embodiments relate to a file-communication system that enables a user to stream high-quality media (for example, from their Dropbox™) During operation, the system streams the media at an initial quality level to a client via a channel. For example, the quality level may be one of a set of quality levels associated with different transcoding operations. Then, the system determines or obtains an indicator of performance for the channel. Based on the indicator, the system spawns an additional transcoding operation at a different quality level than is available in the set of quality levels. The resulting media at the different quality level is then streamed from the system to the client via the channel.

### BACKGROUND

1. Field

The disclosed embodiments generally relate to techniques for sharing media files, such as video or audio files. More specifically, the disclosed embodiments relate to a system that facilitates sharing of media files by providing a media stream that is transcoded based on channel performance.

2. Related Art

Users of an online content management system, such as the Dropbox™ service, provided by Dropbox, Inc. of San Francisco, Calif., often desire to stream content from stored files. For example, a user may stream a video or audio (and, more generally, a type of media) to their client device so that the user can view the video or listen to the audio on their client device in real-time. Typically, such real-time playing of media can be facilitated by pre-transcoding a stored media file at a desired data rate and quality level.

However, pre-transcoding the media file can be time-consuming and expensive. In particular, the content management system may not know in advance which stored media file(s) are potentially of interest to the user at any given time. As a consequence, many files may need to be pre-transcoded, which can consume valuable resources and may significantly increase storage costs. These challenges are often compounded by uncertainty about the communication channel performance which affects the desired data rate and quality level, and as a consequence may necessitate pre-transcoding multiple versions of a stored media file.

Alternatively, a stored media file may be transcoded in real-time. However, it is often difficult for the client device to monitor the channel performance and communicate the desired data rate and quality level to the content management system. As a consequence, the content management system may transcode the stored media file based on a pre-defined data rate and quality level. This may result in a media stream which is transcoded at a quality level that does not match the channel capacity, which can degrade the user's experience.

### SUMMARY

The disclosed embodiments relate to a feature of a file-communication system which improves the user experience by allowing the performance of a channel that is used to stream media to a client from the system to be used as a factor in modifying the data rate and/or the resolution of the media. In particular, an indicator of the channel performance is determined on the server side and then, based on this indicator, one or more additional transcoding operations may be spawned. This approach allows the user to stream media from an online content management system in a way that matches channel performance.

### BRIEF DESCRIPTION OF THE FIGURES

FIG. 1 illustrates a content management environment which includes an online content management system in accordance with the disclosed embodiments.

FIG. 2 presents a flow chart illustrating a process for streaming media in accordance with the disclosed embodiments.

FIG. 3 presents a flow chart illustrating more details about the process illustrated in FIG. 2 in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Content Management Environment

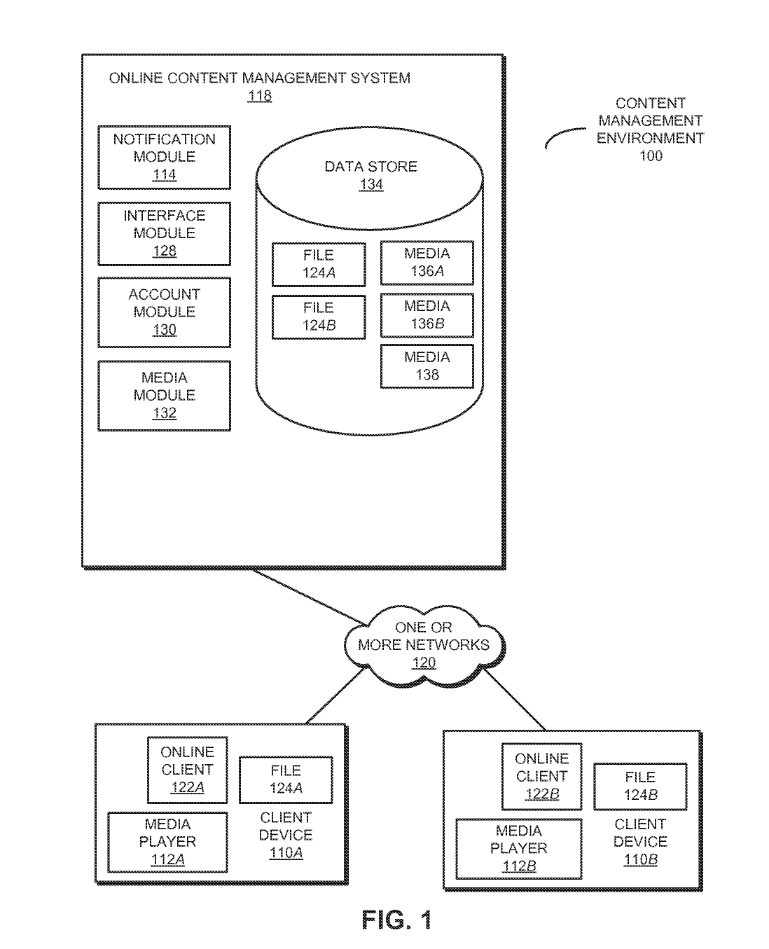

FIG. 1 shows content management environment 100 according to various embodiments. As may be understood from this figure, content management environment 100 includes a plurality of client devices 110A and 110B (collectively 110), and an online content management system 118 (also referred to as a “content management system”), which are all interconnected by one or more networks 120. Various aspects of the client devices 110 and content management system 118 are discussed below.

Client Devices

In various embodiments, each client device 110 may selectively execute an online-service client application 122A and 122B (collectively 122) (also referred to as an “online client”), which may be used to manage files stored within a content management system 118. It is noted that, in some embodiments, synchronized copies of files 124A and 124B may be kept on content management system 118 and each respective client device 110. In some embodiments, client devices 110 may provide a file-browser type interface (not shown) for directly manipulating the files stored on content management system 118 without maintaining a local copy. Online clients 122 may also include functionality for receiving and sending messages to a notification module 114.

While only two client devices 110A and 110B are shown in FIG. 1 for purposes of clarity, it should be understood by those skilled in the relevant field that many client devices 110A and 110B may simultaneously connect through network(s) 120 to content management system 118 at any given time. Examples of suitable client devices 110 include, but are not limited to, a desktop computer; mobile computing devices, such as a laptop or a tablet; and handheld devices, such as a smartphone (e.g., an IPHONE®, BLACKBERRY®, or ANDROID™-based smartphone). Each client device 110 may store a local, synced copy of one or more files from within content management system 118, and the files may be stored in any suitable file format. When online client 122 presents files that are stored within the file storage system to a user, the files may be arranged in folders (or containers) and the folders themselves may be arranged in other folders, or in any other arbitrary arrangement supported by content management system 118, as determined by the user. However, one of skill in the art should understand in light of this disclosure that each user's file-storage architecture may be considerably different from the next, and in some instances, the file-storage architecture may be implemented to maximize storage and file retrieval efficiency.

Content Management System

Content management system 118 stores files and manages access to those files via client devices 110. Content management system 118 and its components may be implemented using any appropriate hardware and software for file serving, storage, and retrieval functions. For example, content management system 118 may be implemented in the form of a single server or multiple servers.

In various embodiments, content management system 118 includes: notification module 114, interface module 128, account module 130, media module 132, and data store 134. Each of these elements of content management system 118 is discussed below.

Content Management System—Notification Module

Notification module 114 may communicate information with client devices 110 and, in particular, with online clients 122. For example, as described further below, notification module 114 may notify one of online clients 122 about a change in the quality level of a media stream from content management system 118 to one of client devices 110.

Content Management System—Interface Module

In particular embodiments, interface module 128 may facilitate file access and file storage among content management system 118 and client devices 110. Interface module 128 may receive files from and send files to client devices 110 consistent with the user's preferences for sharing files. Interface module 128 may act as the counterpart to a client-side file-explorer style user interface that allows a user to manipulate files directly stored on content management system 118. In some embodiments, software operating on client devices 110 may integrate network-stored files with the client's local file system to enable a user to manipulate network-stored files through the same user interface (UI) used to manipulate files on the local file system, e.g., via a file explorer, file finder or browser application. As an alternative or supplement to the client-side file-explorer interface, interface module 128 may provide a web interface for client devices 110 to access (e.g., via a suitable online client 122) and allow a user to manipulate files stored within content management system 118. In this way, the user can directly manipulate files stored within content management system 118.

Content Management System—Data Store

In various embodiments, data store 134 may store files such as those uploaded using client devices 110, or using any other suitable computing device. In the embodiment illustrated in FIG. 1, client device 110A, which is associated with a first user, is shown as locally storing at least one file 124A, and client device 110B, which is associated with a second user, is shown as locally storing at least one file 124B. As shown in FIG. 1, copies of the locally stored files are maintained in data store 134 of content management system 118.

In various embodiments, data store 134 may maintain information identifying the user, information describing the user's file directory, and other information in a file journal that is maintained for each user. In some embodiments, the file journal may be maintained on content management system 118, and in other embodiments, a file journal (e.g., a ‘server-side file journal’) may be maintained on both content management system 118 and locally on each client device 110. In various embodiments, the file journal may be used to facilitate the synchronization of the various copies of a particular file that are associated with a user's account.

As a particular example, in the embodiment shown in FIG. 1, the system may be configured so that any changes that are made to file 124A on particular client device 110A may also be automatically reflected in the copy of file 124A stored within content management system 118 (subject to the delay, if any, associated with uploading file 124A or the changes to file 124A from client device 110A to content management system 118). Similarly, any changes that are made to file 124A on content management system 118 may also be automatically reflected in the copy of file 124A stored on client device 110A (subject to the delay, if any, associated with downloading file 124A or the changes to file 124A from content management system 118 to client device 110A).

Content Management System—Account Module

In particular embodiments, account module 130 may track files stored in data store 134 and entries in the server-side file journal for each file. As users grant file access permissions to other users, account module 130 may update the server-side file journal associated with each relevant user in data store 134. Account module 130 may also track client devices 110 that are associated with each user's account. For example, a user may want to share all their files among their desktop computer, tablet computer, and mobile device. To make such a sharing arrangement seamless to the user, the user's single account on content management system 118 may be associated with each of the user's respective client devices. In some embodiments, an application running on each respective client device 110 may help to coordinate synchronization of files on the client device with corresponding versions of the files within the user's account in content management system 118, and also with corresponding versions of the files stored on the user's various other client devices.

Content Management System—Media Module

In various embodiments, media module 132 may use one or more transcoding devices to transcode one or more of the files that are stored in data store 134 into media 136 (such as video, audio, documents or files). (More generally, media module 132 may transcode one or more content items that are included in files or containers in data store 134.) These transcoded media 136 may have associated quality levels, which are associated with specific data rates and resolutions supported by the channel and/or the client device. For example, media 136 may provide a set of quality levels for specific media. In some embodiments, media 136 are transcoded in real-time, i.e., concurrently as interface module 128 streams at least one of media 136 to one of client devices 110. Alternatively, media 136 may, at least in part, be pre-transcoded. This pre-transcoding may be based on a use context of the one or more files. For example, if a user of one of client devices 110 uses online client 122 to access, stream or modify a file in a container or a folder, the other files (and, more generally, content or content items) in this container may be pre-transcoded, because it is more likely that the user will access these other files in the near future.

Moreover, media module 132 may also spawn one or more additional transcoding operations on one or more media files based on an indicator of channel performance (in the one or more networks 120) while streaming media to one of client devices 110. This indicator may be determined by interface module 128. For example, media module 132 may spawn the one or more additional transcoding operations to allow media 138, having a different quality level from those of media 136, to be streamed to one of client devices 110. Prior to transitioning the streaming from one of media 136 to media 138, media module 132 may instruct notification module 114 to alert the one of client devices 110 of the change in the quality.

### Streaming Process

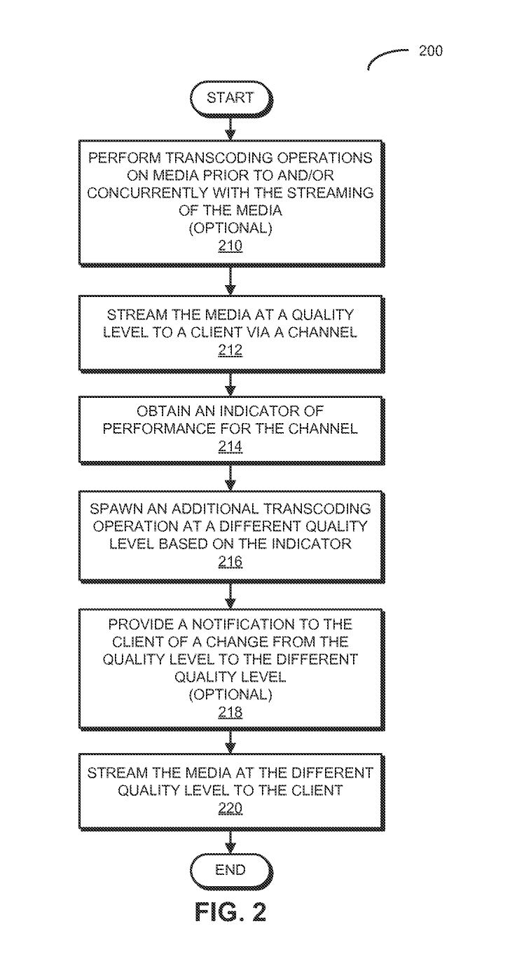

FIG. 2 presents a flow chart illustrating a process 200 for streaming media from a server. Note that process 200 may be performed by modules or components in content management system 118 in FIG. 1, including: interface module 128 and media module 132. During operation, the system streams the media at a specific quality level to a client via a channel (operation 212), wherein the specific quality level is one of a set of quality levels associated with different transcoding operations. Note that a given quality level may be associated with a specific data rate and a resolution. For example, the set of quality levels may include data rates of 250 kb/s, 500 kb/s and 1.5 Mb/s, which may be at the same or different resolutions (such as 360p or 480p). Moreover, the set of quality levels may be predefined (for example, based on available resolutions) or may be dynamically determined (for example, based on a channel performance indicator, which is discussed further below).

In particular, the user of client device 110A may use online client 122A to request that content management system 118 stream media in FIG. 1. In response to the user's request, the system may optionally perform the transcoding operations on the media concurrently with the streaming of the media (operation 210). For example, media module 132 in FIG. 1 may spawn the different transcoding operations for different quality levels for media 136 so that media 136 are transcoded by media module 132 in real-time.

Alternatively or additionally, the system may perform the transcoding operations on the media prior to the streaming of the media (operation 210). Thus, media 136 in FIG. 1 may, at least in part, be pre-transcoded, i.e., before the user's request. For example, the transcoding operations may be performed on the media based on a context of the media relative to other content accessed by the client. This context may include association of the media and the other content with a common container in content management system 118. In particular, if the user accesses one of the media in a container, it is likely that the user will access other files in the container in the near future, so the system may pre-transcode these files. By pre-transcoding at least a portion of media 136, the start-up latency in the media streaming may be reduced or eliminated. Note that a summary of available files in data store 134 and their inter-relationships may be maintained by account module 130 in FIG. 1.

Moreover, in response to the user's request, notification module 114 may provide information that specifies the location of the media in data store 134 to online client 122A in FIG. 1. For example, notification module 114 may provide a uniform resource locator (URL) or link to a web page where the media in data store 134 can be accessed. More generally, notification module 114 may provide information related to a mechanism that facilitates access to the media in data store 134. Then, as described above in operation 212, when the user accesses the location (for example, by activating an icon or a button in a web page associated with the URL that is displayed on client device 110A), interface module 128 and/or media module 132 may stream one of media 136 to online client 122A. Then, media player 112A on client device 110A plays this media for the user. For example, media player 112A may display a video.

Next, the system obtains an indicator of performance for the channel (operation 214). This indicator may be based on performance of the channel as determined from content management system 118. For example, the indicator may be based on the downloading of segments of the media in less time than that needed by the client to view or listen to (and, more generally, play) the media in real-time at the quality level. In the case of video, interface module 128 and/or media module 132 in FIG. 1 may initially stream the first two segments (or 5 s of video) at 250 kb/s and a resolution of 360p. Based on the timing of download requests for segments from online client 122A, interface module 128 can determine whether the first two segments were downloaded in less than 5 s. In particular, online client 122A may stagger the download requests so that, if there is sufficient bandwidth in one or more networks 120, the download requests may occur approximately every 5 s.

Similarly, the indicator may include an inferred available bandwidth of the channel based on the timing of the download requests and associated acknowledgments from the client. In particular, the timing of the download requests for segments and the associated acknowledgments from online client 122A in FIG. 1 may allow interface module 128 to determine a duration of the downloads (and, thus, for a given processing capability, the bandwidth of the one or more networks 120).

Note that the indicator of performance may be based on a wide variety of metrics, including an estimate of: the signal-to-noise ratio, the error rate, a mean-square error relative to a target pattern, and/or a size of an opening in an eye pattern. For example, repeated download requests followed by messages that the data was not received may indicate that the current quality level is too high for the channel to support.

Based on the indicator, the system spawns an additional transcoding operation at a different quality level (operation 216) than is available in the set of quality levels. For example, media module 132 in FIG. 1 may spawn a transcoding operation that produces media 138. In the case of video transcoding, this video may have a data rate of 3 Mb/s and a resolution of 480p.

In some embodiments, the system optionally provides a notification to the client of a change from the quality level to the different quality level (operation 218). For example, notification module 114 in FIG. 1 may provide a message to online client 122A of the change from 250 kb/s and a resolution of 360p, to 3 Mb/s and a resolution of 480p. Alternatively, notification module 114 in FIG. 1 may provide a message to online client 122A of the change from 3 Mb/s and a resolution of 480p, to 250 kb/s and a resolution of 360p (i.e., a downgrade in the quality level). This message or notification may be embedded in the media stream or may be communicated via a side channel, and may allow client device 110A (and, in particular, media player 112A) to adapt to the different quality level.

In some embodiments, the user is able to override the change in the quality level. For example, even though a portable electronic device and a network are able to accommodate a higher quality level, the user may not want the higher quality level to be used because it may consume more of their data plan. In this case, when notification module 114 in FIG. 1 provides a message about an impending change in the quality level, online client 122A in FIG. 1 may respond with an accept or decline message based on: the user's response, or predefined user preferences or user configuration settings.

Next, the system streams the media at the different quality level to the client via the channel (operation 220). For example, interface module 128 and/or media module 132 in FIG. 1 may stream media 138 to online client 122A. Then, media player 112A plays or presents the media to the user.

By allowing adaptation of the transcoded media using server-side intelligence, process 200 may allow the playing quality to be optimized. In particular, the system may obtain the indicator without receiving direct feedback about the performance (such as the error rate or the signal-to-noise ratio) from the client. In this way, the system may be able to infer what the client is doing and/or what the client will do next. This streaming process may eliminate the need to pre-transcode a significant number of files, thereby conserving valuable system resources and reducing storage requirements. In addition, by providing improved media quality, process 200 enhances the user's experience.

While video is used as an illustration of the streaming process in the preceding discussion, in other embodiments additional types of files (such as audio files) and associated transcoding techniques may be used.

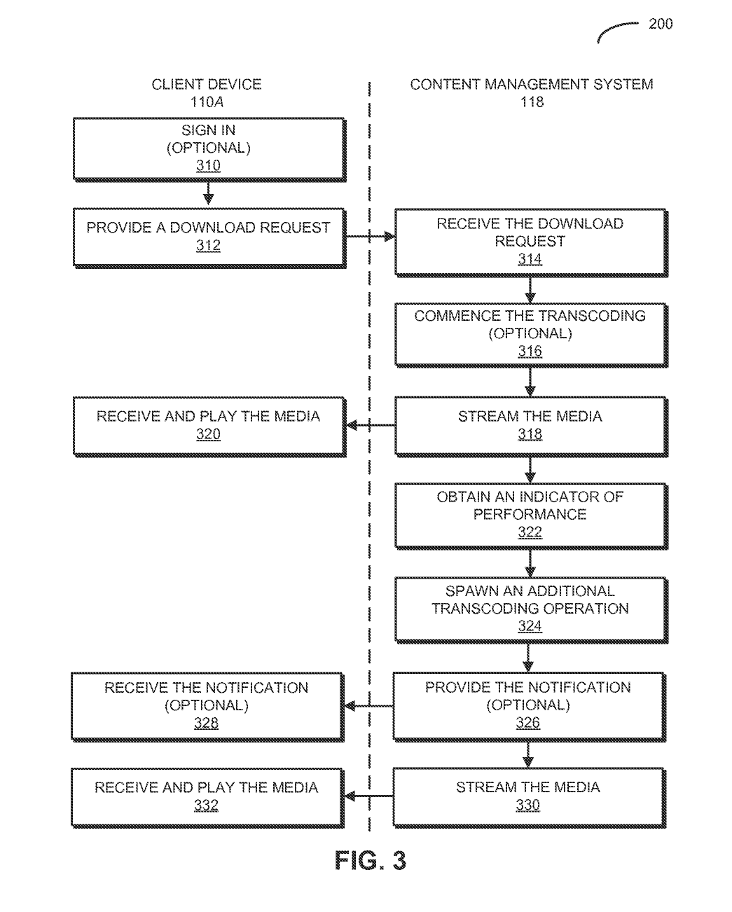

Additional details about process 200 are further illustrated in FIG. 3, which shows the interaction between client device 110A and content management system 118. For example, a user of client device 110A may wish to download or stream media. If the user is not signed in to the online content management system, the user may optionally sign in (operation 310). For example, a dialog box may be displayed that enables the user to sign in to (and, if necessary, to sign up with) the online content management system. Alternatively, the user may not need to be signed in. Instead, the download stream may be triggered by a shared link. This approach may allow the user to share content with other users who are not customers or users of content management system 118 in FIG. 1.

Then, the user makes a download request (operation 312). After this request is received (operation 314), the transcoding may optionally commence (operation 316). (Alternatively or additionally, the media at the different quality levels may, at least in part, be pre-transcoded.)

Next, content management system 118 provides a URL that specifies the location of the transcoded media file in content management system 118. For example, a web page associated with the URL may be displayed on a browser on client device 110A. When the user activates an icon or a button in the web page, the media may be streamed (operation 318) by content management system 118. This media stream may be received and played (operation 320) by client device 110A.

Subsequently, content management system 118 obtains the indicator of the performance (operation 322) of the channel. Based on the indicator, content management system 118 may spawn an additional transcoding operation (operation 324) at a different quality level. Furthermore, a notification may optionally be provided (operation 326) from content management system 118 and may be optionally received (operation 328) at client device 110A.

Then, content management system 118 streams the media (operation 330) at the different quality level. This media stream is then received and played (operation 332) by client device 110A.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A computer-implemented method for streaming media, the method comprising:
using a computer, streaming the media at a quality level from a server to a client via a channel, wherein the quality level is part of a set of quality levels associated with different transcoding operations;
obtaining an indicator of performance for the channel;
spawning an additional transcoding operation at a different quality level than is available in the set of quality levels based on the indicator; and
streaming the media at the different quality level from the server to the client via the channel.

2. The method of claim 1, wherein the server is an online content management system.

3. The method of claim 1, wherein a given quality level is associated with a data rate and a resolution.

4. The method of claim 1, wherein the indicator includes one of: downloading of segments of the media in less time than that needed by the client to play the media in real-time at the quality level; or an inferred available bandwidth of the channel based on timing of download requests and associated acknowledgments from the client.

5. The method of claim 1, wherein, prior to streaming the media, the method further comprises performing the transcoding operations on the media.

6. The method of claim 5, wherein the choice of the transcoding operations that are performed on the media is based on a context of the media relative to other content accessed by the client.

7. The method of claim 6, wherein the context includes association of the media and the other content with a common container in the server.

8. The method of claim 1, wherein the method further comprises performing the transcoding operations on the media concurrently with streaming the media.

9. The method of claim 1, wherein, prior to streaming the media at the different quality level, the method further comprises providing a notification to the client of a change from the quality level to the different quality level.

10. A computer-program product for use in conjunction with a computer system, the computer-program product comprising a non-transitory computer-readable storage medium and a computer-program mechanism embedded therein to stream media, the computer-program mechanism including:
instructions for streaming the media at a quality level from the computer system to a client via a channel, wherein the quality level is part of a set of quality levels associated with different transcoding operations;
instructions for obtaining an indicator of performance for the channel;
instructions for spawning an additional transcoding operation at a different quality level than is available in the set of quality levels based on the indicator; and
instructions for streaming the media at the different quality level from the computer system to the client via the channel.

11. The computer-program product of claim 10, wherein a given quality level is associated with a data rate and a resolution.

12. The computer-program product of claim 10, wherein the performance is determined at a server side of the channel.

13. The computer-program product of claim 10, wherein, prior to the instructions for streaming the media, the computer-program mechanism further comprises instructions for performing the transcoding operations on the media.

14. The computer-program product of claim 13, wherein the choice of the transcoding operations that are performed on the media is based on a context of the media relative to other content accessed by the client.

15. The computer-program product of claim 14, wherein the context includes association of the media and the other content with a common container in the computer system.

16. The computer-program product of claim 10, wherein, prior to the instructions for streaming the media at the different quality level, the computer-program mechanism further comprises instructions for providing a notification to the client of a change from the quality level to the different quality level.

17. The computer-program product of claim 16, wherein, prior to the instructions for streaming the media at the different quality level, the computer-program mechanism further comprises instructions for receiving acceptance of the change to the different quality level from the client.

18. A computer system, comprising:
a processor;
memory; and
a program module, wherein the program module is stored in the memory and configurable to be executed by the processor to stream media, the program module including:
instructions for streaming the media at a quality level from the computer system to a client via a channel, wherein the quality level is part of a set of quality levels associated with different transcoding operations;
instructions for obtaining an indicator of performance for the channel;
instructions for spawning an additional transcoding operation at a different quality level than is available in the set of quality levels based on the indicator; and
instructions for streaming the media at the different quality level from the computer system to the client via the channel.

19. The computer system of claim 18, wherein, prior to the instructions for streaming the media, the program module further comprises instructions for performing the transcoding operations on the media.

20. The computer system of claim 18, wherein the choice of the transcoding operations that are performed on the media is based on a context of the media relative to other content accessed by the client.
